(19) United States
(12) Patent Application Publication
(10) Pub. No.: US 2026/0145655 A1
(43) Pub. Date: May 28, 2026

(54) BRAKE DEVICE FOR VEHICLE

(71) Applicant: SUBARU CORPORATION, Tokyo (JP)

(72) Inventors: Osamu SAITO, Tokyo (JP); Yasuyuki OTA, Tokyo (JP); Yukiko TAKAHASHI, Tokyo (JP); Yoshio AIKO, Tokyo (JP)

(21) Appl. No.: 19/384,667

(22) Filed: Nov. 10, 2025

(30) Foreign Application Priority Data
Nov. 27, 2024 (JP) 2024-206152

(51) Int. Cl. B60T 8/34; B60T 1/06; B60T 8/171; B60T 13/12

(52) U.S. Cl. CPC B60T 8/34; B60T 1/065; B60T 8/171; B60T 13/12; B60T 2220/04; B60T 2250/04

(57) ABSTRACT

A brake device for a vehicle includes a vehicle speed detection unit, a disc brake, a brake hydraulic circuit, a control unit, and a first brake pressure detection unit. The control unit includes a start detection unit, a pressure reduction processing unit, and a pressure increase processing unit. The start detection unit detects a start of the vehicle after a stop of the vehicle based on a vehicle speed detected by the vehicle speed detection unit. When the start of the vehicle is detected by the start detection unit, the pressure reduction processing unit reduces a brake pressure in a hydraulic chamber by operating the brake hydraulic circuit. When the brake pressure detected by the first brake pressure detection unit is lower than a preset first threshold pressure, the pressure increase processing unit increases the brake pressure in the hydraulic chamber by operating the brake hydraulic circuit.

### CROSS-REFERENCE TO RELATED APPLICATIONS

The present application claims priority from Japanese Patent Application No. 2024-206152 filed on Nov. 27, 2024, the entire contents of which are hereby incorporated by reference.

### BACKGROUND

The disclosure relates to a brake device for a vehicle.

A hydraulic disc brake device (hereinafter referred to as “disc brake device”) is known as a brake device for a vehicle such as an automobile or a motorcycle. This type of disc brake device has a disc rotor that rotates together with a wheel, and generates a braking force by pressing both surfaces of the disc rotor between a pair of facing brake pads.

The braking force is obtained by hydraulically actuating a caliper piston slidably inserted into a cylinder of a brake caliper (caliper cylinder) and pressing a brake pad coupled to the piston against the disc rotor. A seal groove is formed in the inner periphery of the caliper cylinder.

A piston seal is fitted into the seal groove. The outer periphery of the caliper piston is in sliding contact with the inner periphery of the piston seal. The piston seal prevents leakage of a brake fluid for operating the caliper piston.

When the brake pressure is increased, the caliper piston slides to press the brake pad against the disc rotor. At this time, the piston seal is elastically deformed following the movement of the caliper piston. When the brake pressure is reduced, the caliper piston is pulled back by a restoring force of the elastically deformed piston seal. When the caliper piston is pulled back, the brake pad is separated from the disc rotor, and the brake is released.

The amount of movement of the caliper piston at the time of brake actuation increases as the brake pressure increases. When the amount of movement of the caliper piston at the time of brake actuation is large, the amount of return at the time of brake release is also large.

Under the influence of the rigidity of the brake caliper and the brake pads, the deterioration of the piston seal, and the like, the resistance force at the time of returning the caliper piston increases. When the return amount of the caliper piston is large, it may be difficult to return the caliper piston to the original position by the restoring force of the piston seal.

When the caliper piston does not return to the original position, the brake pads slide on the disc rotor at the time of starting, and a drag torque is generated. The generation of the drag torque not only causes deterioration of energy consumption performance (fuel economy performance and electric economy performance), but also accelerates wear of the brake pads and the disc rotor to cause a decrease in durability. Further, the drag torque may cause squeaking on the sliding surface of the disc brake.

As a countermeasure, for example, Japanese Unexamined Patent Application Publication (JP-A) No. 2023-144890 discloses a technique in which, when a detection value of a brake pressure detected by a hydraulic pressure sensor exceeds a predetermined threshold during brake actuation, an electrical actuator is operated in a direction in which a caliper piston retreats from a disc rotor when the brake is released thereafter.

### SUMMARY

An aspect of the disclosure provides a brake device for a vehicle. The brake device includes a vehicle speed detection unit, a disc brake, a brake hydraulic circuit, a control unit, and a first brake pressure detection unit. The vehicle speed detection unit is configured to detect a vehicle speed of the vehicle. The disc brake includes a piston, a cylinder, and a piston seal. The piston is configured to press brake pads against a disc rotor. The piston is configured to be inserted into the cylinder. The piston seal is fitted in a seal groove formed in the cylinder and has an inner periphery in sliding contact with the piston. The disc brake has a hydraulic chamber defined by the piston, the cylinder, and the piston seal. The brake hydraulic circuit is configured to supply and discharge a brake fluid to and from the hydraulic chamber. The control unit is configured to control supply and discharge of the brake fluid to and from the hydraulic chamber. The first brake pressure detection unit is configured to detect a brake pressure in the hydraulic chamber. The control unit includes a start detection unit, a pressure reduction processing unit, and a pressure increase processing unit. The start detection unit is configured to detect a start of the vehicle after a stop of the vehicle based on the vehicle speed detected by the vehicle speed detection unit. The pressure reduction processing unit is configured to, when the start of the vehicle is detected by the start detection unit, reduce the brake pressure in the hydraulic chamber by operating the brake hydraulic circuit. The pressure increase processing unit is configured to, when the brake pressure detected by the first brake pressure detection unit is lower than a preset first threshold pressure, increase the brake pressure in the hydraulic chamber by operating the brake hydraulic circuit.

An aspect of the disclosure provides a brake device for a vehicle. The brake device includes a vehicle speed detection unit, a disc brake, a brake hydraulic circuit, circuitry, and a first brake pressure detection unit. The vehicle speed detection unit includes a sensor and is configured to detect a vehicle speed of the vehicle. The disc brake includes a piston, a cylinder, and a piston seal. The piston is configured to press brake pads against a disc rotor. The piston is configured to be inserted into the cylinder. The piston seal is fitted in a seal groove the cylinder and has an inner periphery in sliding contact with the piston. The disc brake has a hydraulic chamber defined by the piston, the cylinder, and the piston seal. The brake hydraulic circuit is configured to supply and discharge a brake fluid to and from the hydraulic chamber. The circuitry is configured to control supply and discharge of the brake fluid to and from the hydraulic chamber. The first brake pressure detection unit includes a sensor and is configured to detect a brake pressure in the hydraulic chamber. The circuitry is configured to detect a start of the vehicle after a stop of the vehicle based on the vehicle speed detected by the vehicle speed detection unit. The circuitry is configured to, upon detecting the start of the vehicle, reduce the brake pressure in the hydraulic chamber by operating the brake hydraulic circuit. The circuitry is configured to, when the brake pressure detected by the first brake pressure detection unit is lower than a preset first threshold pressure, increase the brake pressure in the hydraulic chamber by operating the brake hydraulic circuit.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic cross-sectional view of a main part of a disc brake;

FIG. 2 is a configuration diagram of a brake control calculation unit;

FIG. 3 is a configuration diagram of a brake hydraulic circuit and a brake pedal mechanism;

FIG. 4 is a flowchart illustrating a brake dragging suppression control routine;

FIG. 5 is an enlarged cross-sectional view illustrating a state of a piston seal at the time of brake actuation;

FIG. 6 is an enlarged cross-sectional view illustrating a state of the piston seal at the time of brake pressure reduction; and

FIG. 7 is an enlarged cross-sectional view illustrating a state of the piston seal after brake pressure slight increase.

### DETAILED DESCRIPTION

In the technique disclosed in JP-A No. 2023-144890, the electrical actuator is used to forcibly return the caliper piston. However, when the caliper piston is uniformly returned by the electrical actuator, excessive return may occur.

When the caliper piston is excessively returned, an ineffective period occurs until the brake is actually actuated in the subsequent brake operation. The ineffective period causes a delay in the brake actuation.

It is desirable to provide a brake device for a vehicle that can quickly suppress generation of a drag torque at the time of starting after brake release, and can prevent a delay in brake actuation at the time of the next brake operation by suppressing excessive return of a piston.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

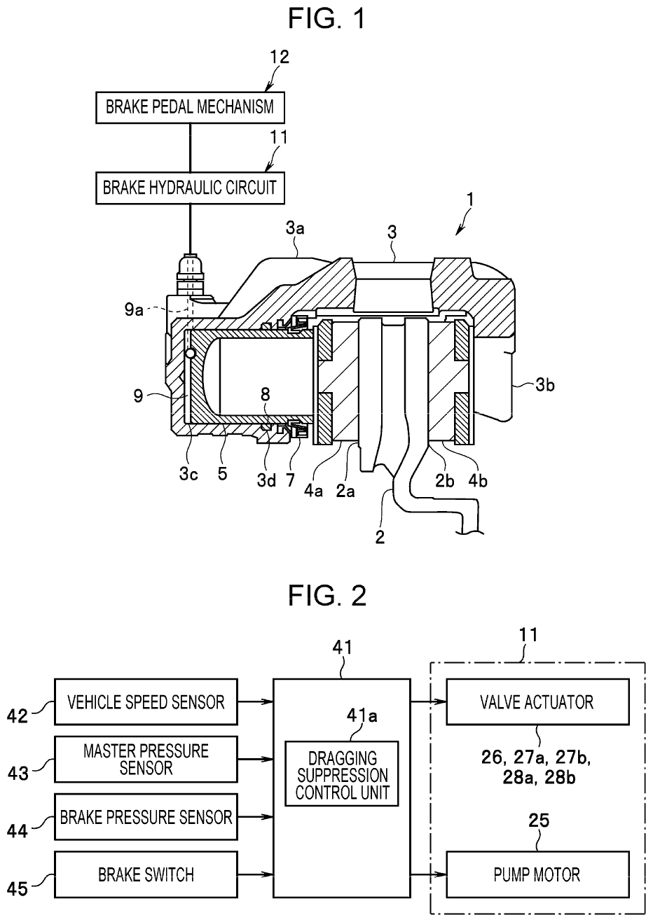

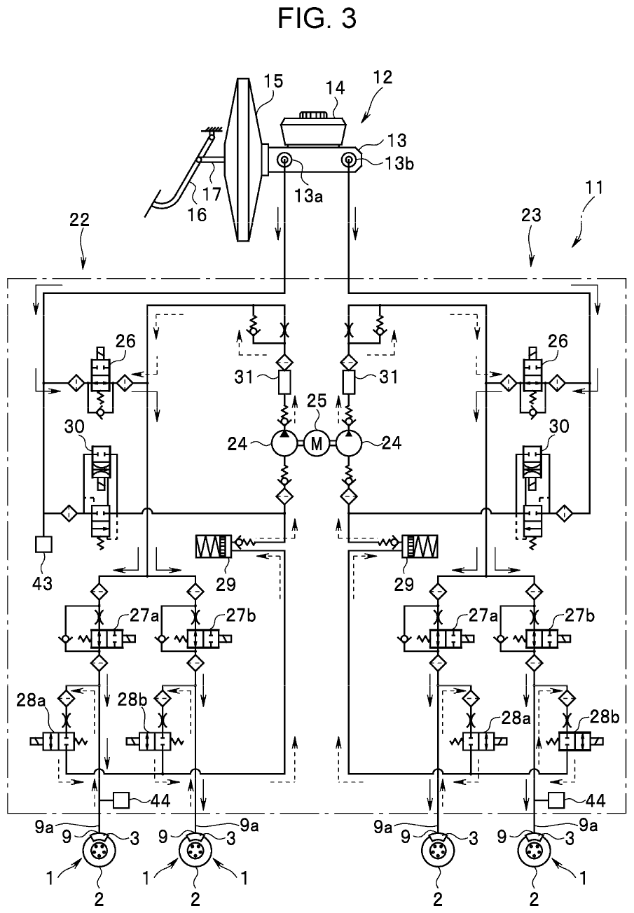

A brake device according to the embodiment includes, as main components, a disc brake 1 illustrated in FIG. 1, a brake control calculation unit 41 illustrated in FIG. 2, a brake hydraulic circuit 11 illustrated in FIG. 3, and a brake pedal mechanism 12.

FIG. 1 illustrates the caliper floating disc brake 1. In the present embodiment, the disc brake 1 is disposed on each of four wheels, that is, front, rear, left, and right wheels. The disc brake 1 is mainly used as a service brake, but may be used as a parking brake. The disc brake 1 includes a disc rotor 2, a brake caliper 3, an inner brake pad 4a, and an outer brake pad 4b.

The disc rotor 2 is coupled to a wheel hub (not illustrated) and rotates together with a wheel. The brake caliper 3 is attached to a suspension via a mounting bracket (not illustrated). The brake caliper 3 has a caliper body 3a and a hook 3b. The caliper body 3a is disposed near an inner pressure receiving surface 2a of the disc rotor 2.

The hook 3b extends over the disc rotor 2 from the caliper body 3a, and faces an outer pressure receiving surface 2b of the disc rotor 2. In the present embodiment, the term “inner” refers to an inner side in a width direction of a vehicle body, and the term “outer” refers to an outer side in the width direction of the vehicle body. The mounting bracket supports the brake caliper 3 via a pin mechanism (not illustrated) so that the brake caliper 3 is movable in an axial direction of the disc rotor 2.

The inner brake pad 4a is disposed between the caliper body 3a and the inner pressure receiving surface 2a of the disc rotor 2. The outer brake pad 4b is disposed between the hook 3b and the outer pressure receiving surface 2b of the disc rotor 2. A back surface of the inner brake pad 4a is fixed to a pressing surface of the caliper piston 5. A back surface of the outer brake pad 4b is fixed to the hook 3b. The caliper piston 5 is slidably inserted into a cylinder (caliper cylinder) 3c formed in the caliper body 3a.

A space between the outer periphery on the pressing surface side of the caliper piston 5 and the opening of the caliper cylinder 3c is closed by a dust boot 7 formed in an annular shape. The dust boot 7 prevents dust from entering the caliper cylinder 3c from the outside. The dust boot 7 is formed in a bellows shape, and expands and contracts following the sliding of the caliper piston 5.

A seal groove 3d is formed in an annular shape on the inner periphery of the caliper cylinder 3c. An outer edge portion of a piston seal 8 is fitted into the seal groove 3d. The piston seal 8 is made of an elastic material such as ethylene propylene rubber (EPMD). The inner periphery of the piston seal 8 protrudes slightly inward from the inner periphery of the caliper cylinder 3c. The outer periphery of the caliper piston 5 is in sliding contact with the inner periphery of the piston seal 8, and the gap between the caliper cylinder 3c and the caliper piston 5 is sealed.

A closed hydraulic chamber 9 is defined by the caliper piston 5, the caliper cylinder 3c, and the piston seal 8. One end of a hydraulic passage 9a is open to the hydraulic chamber 9. The other end of the hydraulic passage 9a protrudes to the outside of the caliper body 3a. The brake hydraulic circuit (hydraulic unit) 11 communicates with the other end of the hydraulic passage 9a protruding to the outside. The brake pedal mechanism 12 is coupled to the brake hydraulic circuit 11.

The brake pedal mechanism 12 is operated when a driver who drives the vehicle intends to decelerate the vehicle. As illustrated in FIG. 3, the brake pedal mechanism 12 includes a tandem brake master cylinder (hereinafter simply referred to as “master cylinder”) 13, a reservoir tank 14 attached to the master cylinder 13, and a brake pedal 16 coupled to the master cylinder 13 via a brake booster 15, and the reservoir tank 14 stores a brake fluid. The brake pedal 16 is coupled to the brake booster 15 via an operating rod 17.

When the driver depresses the brake pedal 16, the brake booster 15 intensifies the depression force applied to the brake pedal 16 to press a piston of the master cylinder 13. Then, the brake fluid in the master cylinder 13 is pressed, and the brake fluid in the brake hydraulic circuit 11 is supplied to the hydraulic chamber 9 of the brake caliper 3. The hydraulic pressure supplied to the hydraulic chamber 9 presses the inner brake pad 4a via the caliper piston 5, and both the brake pads 4a and 4b press the pressure receiving surfaces 2a and 2b of the disc rotor 2 by a floating operation of the brake caliper 3.

FIG. 3 illustrates a configuration of the brake hydraulic circuit 11. The brake hydraulic circuit 11 is already employed in brake control such as an antilock brake system (ABS) and vehicle dynamics control (VDC).

The brake hydraulic circuit 11 is constituted by two independent systems that are a primary hydraulic circuit 22 and a secondary hydraulic circuit 23. The two systems of the primary hydraulic circuit 22 and the secondary hydraulic circuit 23 are formed by cross piping or front and rear piping. Since the primary hydraulic circuit 22 and the secondary hydraulic circuit 23 have the same configuration, the same reference numerals are given to simplify the description below.

Since a pump motor 25 is stopped in an initial state in which the brake hydraulic circuit 11 is not operated, a pump 24 is also stopped. When the driver depresses the brake pedal 16 in this state, the brake fluid in the master cylinder 13 flows in the direction indicated by the solid line arrow. That is, the brake fluid flows into the hydraulic chamber 9 of the brake caliper 3 through a normally open normal-pressure valve 26, a bifurcated passage, the normally open holding valves 27a and 27b, and the hydraulic passage 9a.

When the brake fluid is supplied to the hydraulic chamber 9, the caliper piston 5 and the caliper body 3a are moved in opposite directions by the pressure of the brake fluid. As illustrated in FIG. 1, the caliper piston 5 presses the inner brake pad 4a against the inner pressure receiving surface 2a of the disc rotor 2. The hook 3b permanently affixed to the caliper body 3a presses the outer brake pad 4b against the outer pressure receiving surface 2b of the disc rotor 2 by the reaction force.

As a result, both the pressure receiving surfaces 2a and 2b of the disc rotor 2 are pressed by both the brake pads 4a and 4b, and each wheel is braked.

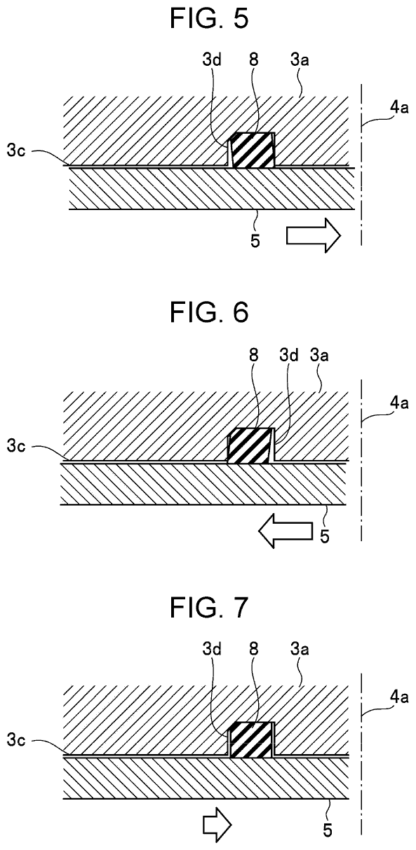

As indicated by the arrow in FIG. 5, when the caliper piston 5 slides toward the inner brake pad 4a, the inner periphery of the piston seal 8 in sliding contact with the outer periphery of the caliper piston 5 is elastically deformed following the movement of the caliper piston 5. The amount of elastic deformation increases as the amount of movement of the caliper piston 5 increases (as the brake force increases).

When the driver releases the depression force applied to the brake pedal 16, the brake pressure in the hydraulic chamber 9 is reduced. Then, the caliper piston 5 is returned by a restoring force of the piston seal 8, and the pressing of both the pressure receiving surfaces 2a and 2b of the disc rotor 2 by both the brake pads 4a and 4b is terminated. Thus, the brake applied to each wheel is released.

When the amount of elastic deformation of the piston seal 8 is large during the brake release, it may be difficult to return the caliper piston 5 to the original position by the restoring force of the piston seal 8 alone. When the caliper piston 5 does not return to the original position, a drag torque is generated.

As will be described later, the brake control calculation unit 41 illustrated in FIG. 2 operates actuators (valve actuators) of the valves 26, 27a, 27b, 28a, and 28b provided in the brake hydraulic circuit 11 and the pump motor 25 to control supply and discharge of the brake fluid to and from the hydraulic chamber 9.

The brake control calculation unit 41 is constituted by a microcontroller. The microcontroller includes a CPU, a RAM, a ROM, a rewritable nonvolatile memory (flash memory or EEPROM), and peripheral devices. The RAM of the microcontroller is provided as a work area of the CPU, and temporarily stores various data in the CPU. The ROM stores programs, fixed data, and the like necessary for the CPU to execute each process. The CPU is also called “microprocessor (MPU)” or “processor.” A graphics processing unit (GPU) or a graph streaming processor (GSP) may be used instead of the CPU. The CPU, the GPU, and the GSP may be selectively combined.

A dragging suppression control unit 41a is provided in the brake control calculation unit 41. The dragging suppression control unit 41a has a function of assisting the restoration of the piston seal 8 at the time of brake release, and suppressing the generation of the drag torque.

The dragging suppression control unit 41a assists the restoration of the piston seal 8 at the time of brake release by using the brake hydraulic circuit 11.

To the input side of the brake control calculation unit 41, a vehicle speed sensor 42 as a vehicle speed detection unit, a master pressure sensor 43 as a second brake pressure detection unit, a brake pressure sensor 44 as a first brake pressure detection unit, and a brake switch 45 are coupled as sensors that detect the generation of the brake drag torque.

The vehicle speed sensor 42 detects the speed of the vehicle (vehicle speed). The vehicle speed sensor 42 may be constituted by wheel speed sensors provided to four wheels. In this case, the vehicle speed sensor 42 detects the vehicle speed from an average value of the wheel speeds of the wheels detected by the wheel speed sensors. The master pressure sensor 43 detects a master pressure supplied from the master cylinder 13.

The brake pressure sensor 44 detects a pressure of the brake fluid supplied to the hydraulic chamber 9. The brake switch 45 is a switch that detects depression of the brake pedal 16 by the driver. The brake switch 45 is turned ON when the driver depresses the brake pedal 16, and is turned OFF when the driver releases the depression of the brake pedal 16.

The actuators (valve actuators) of the valves 26, 27a, 27b, 28a, and 28b and the pump motor 25 that operate the brake hydraulic circuit 11 when reducing the brake pressure at the time of brake release are coupled to the output side of the brake control calculation unit 41. The operations of the actuators of the valves 26, 27a, 27b, 28a, and 28b and the pump motor 25 when reducing the brake pressure at the time of brake release will be described later.

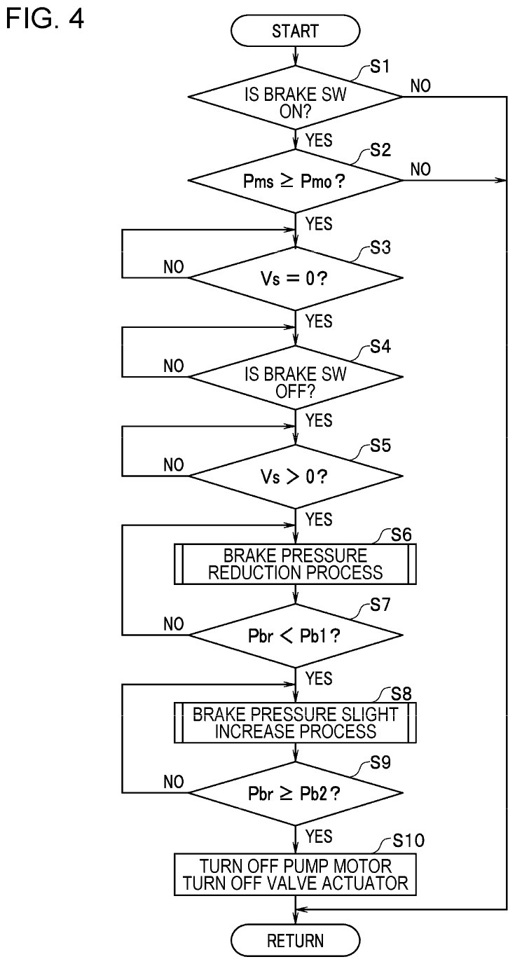

Brake dragging suppression control to be executed by the dragging suppression control unit 41a is specifically processed according to a brake dragging suppression control routine illustrated in FIG. 4. This routine is executed at every predetermined calculation cycle after the driver turns ON the system.

When the system is started, the dragging suppression control unit 41a first checks whether the brake switch 45 is ON (step S1). When the brake switch 45 is ON (YES), the driver is depressing the brake pedal 16. When the brake switch 45 is OFF (NO), the driver is releasing the depression of the brake pedal 16, and the routine is terminated.

When it is determined that the brake switch 45 is ON (step S1: YES), the dragging suppression control unit 41a compares a master pressure Pms detected by the master pressure sensor 43 with a depression determination pressure Pmo (step S2). The driver tends to relatively strongly depress the brake pedal 16 when stopping the vehicle. The depression determination pressure Pmo is a value for determining whether the driver strongly depresses the brake pedal 16 when the driver stops the vehicle while decelerating the vehicle. The depression determination pressure Pmo is set in advance for each vehicle type based on an experiment or the like.

When Pms≥Pmo (YES), the dragging suppression control unit 41a determines that the driver is depressing the brake pedal 16 with a relatively strong force. When Pms<Pmo (NO), the dragging suppression control unit 41a determines that the driver is depressing the brake pedal 16 with a normal depression force, and terminates the routine.

When it is determined that Pms≥Pmo (step S2: YES), the dragging suppression control unit 41a reads a vehicle speed Vs detected by the vehicle speed sensor 42, and determines whether the vehicle has stopped (step S3). When it is determined that the vehicle is traveling (Vs>0: NO), the dragging suppression control unit 41a waits until the vehicle stops.

When it is determined that the vehicle has stopped (Vs=0: YES), the dragging suppression control unit 41 a checks whether the brake switch 45 is turned OFF (step S4). When the system is turned OFF after the vehicle has stopped, this routine is terminated.

When it is determined that the brake switch 45 is continuously ON (NO), the dragging suppression control unit 41a waits until the brake switch 45 is turned OFF. When it is determined that the brake switch 45 is turned OFF (YES), the dragging suppression control unit 41a reads the vehicle speed Vs detected by the vehicle speed sensor 42, and checks whether the vehicle is started (step S5). In one embodiment of the disclosure, the processing in step S5 serves as a start detection unit.

When it is determined that the vehicle is stopped (Vs=0) (step S5: NO), the dragging suppression control unit 41 a waits until the vehicle is started. When it is determined that the vehicle is started (Vs>0) (YES), the dragging suppression control unit 41a executes control to reduce the brake pressure (step S6).

The driver continues to depress the brake pedal 16 while the vehicle is stopped. When starting the vehicle, the depression of the brake pedal 16 is released, and an accelerator pedal is depressed. In this way, the operation in which the driver releases the depression of the brake pedal 16 and then depresses the accelerator pedal continues. Therefore, when the caliper piston 5 does not return to the original position immediately after the driver releases the brake pedal 16, a drag torque is generated.

In step S6, the dragging suppression control unit 41a quickly reduces a brake pressure Pbr in the hydraulic chamber 9 when the driver tries to start the vehicle. As the control to reduce the brake pressure, the dragging suppression control unit 41a first turns ON the pump motor 25. Next, the dragging suppression control unit 41a closes the normally open holding valves 27a and 27b and opens the normally closed pressure reducing valves 28a and 28b.

When the pump motor 25 is turned ON, the pump 24 is driven, and as indicated by the broken line arrow in FIG. 3, the brake fluid stored in the hydraulic chamber 9 of the brake caliper 3 is sucked by the pump 24 through the pressure reducing valves 28a and 28b and a reservoir 29. The sucked brake fluid is returned toward the master cylinder 13 through a damper chamber 31 and the normal-pressure valve 26. Then, the brake pressure in the hydraulic chamber 9 is positively reduced, and the caliper piston 5 is returned. Thus, the restoration of the piston seal 8 is assisted, and the generation of the drag torque is quickly suppressed.

Then, the dragging suppression control unit 41a compares the brake pressure Pbr in the hydraulic chamber 9 detected by the brake pressure sensor 44 with a preset first threshold pressure Pb1 (step S7). The first threshold pressure Pb1 is a fixed value set in advance for each vehicle type. To quickly suppress the drag torque, it is necessary to reduce the brake pressure Pbr in the hydraulic chamber 9 to be lower than the brake pressure when the driver releases the depression of the brake pedal 16.

The first threshold pressure Pb1 is a brake pressure required to release the pressing of the pressure receiving surfaces 2a and 2b between the brake pads 4a and 4b before the vehicle speed at the time of starting reaches a predetermined vehicle speed (for example, 5 km/h). The first threshold pressure Pb1 is a fixed value set in advance for each vehicle type based on an experiment or the like.

When Pbr≥Pb1 (step S7: NO), the dragging suppression control unit 41a returns to step S6 and repeatedly executes the brake pressure reduction process. When the dragging suppression control unit 41a detects that Pbr<Pb1 (step S7: YES), the dragging suppression control unit 41a executes a slight increase process for slightly increasing the brake pressure (step S8). In one embodiment of the disclosure, the processing in steps S6 and S7 serves as a pressure reduction processing unit.

When the pressure in the hydraulic chamber 9 is rapidly reduced by the brake hydraulic circuit 11, the caliper piston 5 is excessively returned from the original position. As illustrated in FIG. 6, the inner periphery of the piston seal 8 in sliding contact with the caliper piston 5 is elastically deformed following the return of the caliper piston 5. Due to this elastic deformation, the restoring force remains in the piston seal 8 as an internal stress, and the durability decreases.

Due to the excessive return of the caliper piston 5, the gaps between the brake pads 4a and 4b and the pressure receiving surfaces 2a and 2b of the disc rotor 2 increase. When the gaps between the brake pads 4a and 4b and the pressure receiving surfaces 2a and 2b of the disc rotor 2 increase, an ineffective period occurs at the time of next depression of the brake pedal 16 by the driver. When the ineffective period is occurs in the brake operation, a delay occurs in actuation of the brake, and the effectiveness of the brake is deteriorated. The delay in actuation of the brake causes the driver to feel discomfort at the time of brake operation.

Therefore, when the dragging suppression control unit 41a detects that Pbr<Pb1 (step S7: YES), the dragging suppression control unit 41a executes a process of slightly increasing the brake pressure Pbr (step S8). When slightly increasing the brake pressure Pbr, the dragging suppression control unit 41a first continues the ON state of the pump motor 25 from the processing in step S6. Next, the dragging suppression control unit 41a closes the normal-pressure valve 26. The dragging suppression control unit 41a opens the holding valves 27a and 27b and closes the pressure reducing valves 28a and 28b.

Then, the brake fluid stored in the reservoir 29 is supplied to the hydraulic chamber 9 of each brake caliper 3 via the pump 24. As a result, the caliper piston 5 and the caliper body 3a are separated from each other by the pressure of the brake fluid supplied to the hydraulic chamber 9. Then, the caliper piston 5 and the hook 3b move toward their original positions, and the gaps between the brake pads 4a and 4b and the pressure receiving surfaces 2a and 2b of the disc rotor 2 are narrowed.

Then, the dragging suppression control unit 41a compares the brake pressure Pbr detected by the brake pressure sensor 44 with a second threshold pressure (step S9). The second threshold pressure is a value (for example, 1 MPa) for returning the caliper piston 5 to the original position (initial position). The second threshold pressure is obtained in advance from an experiment or the like and is set for each vehicle type.

When Pbr<Pb2 (step S9: NO), the dragging suppression control unit 41a repeatedly executes the brake pressure slight increase process. When the dragging suppression control unit 41a detects that Pbr≥Pb2 (step S9: YES), the dragging suppression control unit 41a turns OFF the pump motor 25 and the actuators of the valves 26, 27a, 27b, 28a, and 28b (step S10), and terminates the routine.

As a result, the brake hydraulic circuit 11 is returned to the initial state in which the brake hydraulic circuit 11 is not operated. As illustrated in FIG. 7, the caliper piston 5 is returned to the original position, and the restoring force (internal stress) remaining in the piston seal 8 is released. In one embodiment of the disclosure, the processing in steps S8 to S10 serves as a pressure increase processing unit.

As described above, according to the present embodiment, when the driver intends to start the vehicle after stopping the vehicle by strongly depressing the brake pedal 16 to stop the vehicle, the dragging suppression control unit 41a operates the brake hydraulic circuit 11 to quickly reduce the brake pressure in the hydraulic chamber 9 of the brake caliper 3. Therefore, the generation of the drag torque can be suppressed.

Since the brake pressure in the hydraulic chamber 9 of the brake caliper 3 is quickly reduced by the brake hydraulic circuit 11, the generation of the drag torque can be quickly suppressed even if the resistance force at the time of returning the caliper piston 5 increases due to the influence of the rigidity of the brake caliper 3 and the brake pads 4a and 4b, the deterioration of the piston seal 8, and the like.

Since the pressure of the brake in the hydraulic chamber is slightly increased after the pressure is reduced by the brake hydraulic circuit 11, the excessive return of the caliper piston 5 is suppressed, and the caliper piston 5 can be quickly returned to the original position. Since the caliper piston 5 can be quickly returned to the original position, the ineffective period does not occur in the next brake operation, and the delay in brake actuation can be suppressed.

The embodiment of disclosure is not limited to the above embodiment. For example, the disc brake 1 is not limited to the caliper floating disc brake, and may be a piston facing disc brake.

According to the embodiment of the disclosure, when the start of the vehicle after the stop of the vehicle is detected, the brake hydraulic circuit is operated to reduce the brake pressure in the hydraulic chamber provided to the disc brake. Therefore, it is possible to quickly suppress the generation of the drag torque at the start of the vehicle after the release of the brake. Since the brake pressure in the hydraulic chamber is increased after the brake pressure is reduced, the excessive return of the piston is suppressed, the ineffective period does not occur at the time of next brake operation, and the delay in brake actuation can be suppressed.

The brake control calculation unit 41 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the brake control calculation unit 41 including the dragging suppression control unit 41a. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A brake device for a vehicle, the brake device comprising:
a vehicle speed detection unit configured to detect a vehicle speed of the vehicle;
a disc brake comprising a piston configured to press brake pads against a disc rotor, a cylinder into which the piston is configured to be inserted, and a piston seal fitted in a seal groove formed in the cylinder and having an inner periphery in sliding contact with the piston, the disc brake having a hydraulic chamber defined by the piston, the cylinder, and the piston seal;
a brake hydraulic circuit configured to supply and discharge a brake fluid to and from the hydraulic chamber;
a control unit configured to control supply and discharge of the brake fluid to and from the hydraulic chamber; and
a first brake pressure detection unit configured to detect a brake pressure in the hydraulic chamber,
wherein
the control unit comprises:
a start detection unit configured to detect a start of the vehicle after a stop of the vehicle based on the vehicle speed detected by the vehicle speed detection unit;
a pressure reduction processing unit configured to, when the start of the vehicle is detected by the start detection unit, reduce the brake pressure in the hydraulic chamber by operating the brake hydraulic circuit; and
a pressure increase processing unit configured to, when the brake pressure detected by the first brake pressure detection unit is lower than a preset first threshold pressure, increase the brake pressure in the hydraulic chamber by operating the brake hydraulic circuit.

2. The brake device for the vehicle according to claim 1, wherein the pressure increase processing unit is configured to stop an operation of the brake hydraulic circuit when the brake pressure detected by the first brake pressure detection unit is higher than a preset second threshold pressure.

3. The brake device for the vehicle according to claim 1, further comprising:
a brake pedal mechanism for a driver who drives the vehicle to perform a brake operation; and
a second brake pressure detection unit configured to detect a brake pressure generated by the brake pedal mechanism, wherein
the pressure reduction processing unit is configured to reduce the brake pressure in the hydraulic chamber when the brake pressure detected by the second brake pressure detection unit exceeds a preset depression determination pressure.

4. A brake device for a vehicle, the brake device comprising:
a vehicle speed detection unit comprising a sensor, the vehicle speed detection unit being configured to detect a vehicle speed of the vehicle;
a disc brake comprising a piston configured to press brake pads against a disc rotor, a cylinder into which the piston is configured to be inserted, and a piston seal fitted in a seal groove formed in the cylinder and having an inner periphery in sliding contact with the piston, the disc brake having a hydraulic chamber defined by the piston, the cylinder, and the piston seal;
a brake hydraulic circuit configured to supply and discharge a brake fluid to and from the hydraulic chamber;
circuitry configured to control supply and discharge of the brake fluid to and from the hydraulic chamber; and
a first brake pressure detection unit comprising a sensor, the first brake pressure detection unit being configured to detect a brake pressure in the hydraulic chamber,
wherein
the circuitry is configured to:
detect a start of the vehicle after a stop of the vehicle based on the vehicle speed detected by the vehicle speed detection unit;
upon detecting the start of the vehicle, reduce the brake pressure in the hydraulic chamber by operating the brake hydraulic circuit; and
when the brake pressure detected by the first brake pressure detection unit is lower than a preset first threshold pressure, increase the brake pressure in the hydraulic chamber by operating the brake hydraulic circuit.
